(19) United States
(12) Patent Application Publication
(10) Pub. No.: US 2026/0057565 A1
(43) Pub. Date: Feb. 26, 2026

(54) DNN GENERATED SYNTHETIC DATA USING PRIMITIVE FEATURES

(71) Applicant: Cognata Ltd., Rehovot (IL)

(72) Inventor: Dan ATSMON, Rehovot (IL)

(73) Assignee: Cognata Ltd., Rehovot (IL)

(21) Appl. No.: 19/104,423

(22) PCT Filed: Aug. 16, 2023
(86) PCT No.: PCT/IL2023/050866

§ 371 Date: Feb. 18, 2025

Related U.S. Application Data
(60) Provisional application No. 63/398,906, filed on Aug. 18, 2022.

(51) Int. Cl. G06T 11/00; G06N 3/0475; G06N 3/08

(52) U.S. Cl. CPC G06T 11/00; G06N 3/0475; G06N 3/08

(57) ABSTRACT

A system for training a generative machine learning model, comprising: a hardware processor, configured for: extracting a plurality of real primitive features from a plurality of real images captured by a sensor in a physical environment; extracting a plurality of other primitive features from a plurality of other images depicting another physical environment; training a generative machine learning model to produce a refined image in response to a synthetic image, the training using the plurality of real images, the plurality of real primitive features, the plurality of other images and the plurality of other primitive features, where the generative machine learning model is adapted for receiving the plurality of real primitive features and additionally or alternatively the plurality of other primitive features as input, to produce a trained model; and providing the trained model to another hardware processor for the purpose of generating synthetic training data.

### RELATED APPLICATION/S

This application claims the benefit of priority of U.S. Provisional Ser. No. 63/398,906 filed on 18 Aug. 2022, the contents of which are incorporated herein by reference in their entirety.

### BACKGROUND

Some embodiments described in the present disclosure relate to a system and method for creating synthetic data and, more specifically, but not exclusively, to a system and method for creating synthetic data for training a perception model of an autonomous computerized system, and additionally or alternatively testing the perception model, verifying the perception model, validating the perception model or any combination thereof.

The term “machine perception”, as used herewithin, refers to the capability of a computerized system to interpret data to derive meaningful information in a manner that is similar to the way humans use their senses to derive meaningful information from the world around them. Thus, machine perception refers to detecting and additionally or alternatively recognizing objects in digital data representing a scene. In the field of machine perception, recognition of an object is done by way of classification. Thus, as used herewithin, machine perception refers to detection of objects in digital data and additionally or alternatively classification of the detected objects. The digital data may comprise one or more digital signals captured by a sensor in a physical scene. For example, a signal may be a digital image captured by a camera, or a digital video captured by a video camera, from a physical scene. Machine perception is not limited to visual signals. For example, a signal may be an audio signal captured by a microphone placed in a street. In another example, a signal may be captured by a thermal sensor, for example a thermal sensor of a security system. The digital data may comprise one or more digital signals simulating signals captured in a physical scene.

As used herewithin, the terms “autonomous system” and “autonomous computerized system” both refer to a computerized system having the ability to operate independently, make decisions, and perform tasks without constant human intervention, and the terms are used interchangeably. Some autonomous systems use machine perception. There is an increase in an amount of systems and in an amount of types of systems that use machine perception, for example in the field of driving. The term “autonomous driving system” (ADS) refers to a vehicle that is capable of sensing its environment and moving safely with some human input. The term “advanced driver-assistance system” (ADAS) refers to a system that aids a vehicle driver while driving by sensing its environment. A vehicle comprising an ADAS may comprise one or more sensors, each capturing a signal providing input to the ADAS. Both and ADS and an ADAS are types of autonomous systems.

It is common practice to use machine learning techniques to generate a machine perception model. Accuracy of a machine learning model depends on the diversity of data used when training it. To produce a robust machine learning model for machine perception there is a need to provide the model with a large variety of the objects the model is expected to detect and classify, in terms of types, size, distance, orientation, lighting, backgrounds etc. As it is expensive to capture such a variety of scenarios, some systems comprising a perception model are trained using synthetic training data.

### SUMMARY

It is an object of some embodiments described in the present disclosure to provide a system and a method for creating synthetic data. In such embodiments, a generative machine learning model is adapted to receive a plurality of primitive features extracted from one or more sets of images provided to the generative machine learning model for training, and the generative machine learning model is trained using the one or more sets of images and the plurality of primitive features to produce a refined image in response to a synthetic image. Adapting the generative machine learning model to receive the plurality of primitive features extracted from the one or more sets of images provided thereto for training facilitates emphasizing in training said model features that are of importance in underlying patterns in the one or more sets of images. Emphasizing in training features that are of importance reduces a likelihood of said model, after being trained, being over fitted to the one or more sets of images, increasing accuracy of an output produced by said model after training. Using a model modified at least in part to receive the plurality of primitive features as input enables control over where in the model's computation the primitive features are introduced, increasing their contribution to the accuracy of the output produced by the model and thus increasing accuracy of said output.

The foregoing and other objects are achieved by the features of the independent claims. Further implementation forms are apparent from the dependent claims, the description and the figures.

According to a first aspect, a system for training a generative machine learning model comprises: at least one hardware processor, configured for: extracting a plurality of real primitive features from a plurality of real images captured by a sensor in a physical environment; extracting a plurality of other primitive features from a plurality of other images depicting another physical environment; training a generative machine learning model to produce a refined image in response to a synthetic image, the training using the plurality of real images, the plurality of real primitive features, the plurality of other images and the plurality of other primitive features, where at least part of the generative machine learning model is adapted for receiving the plurality of real primitive features and additionally or alternatively the plurality of other primitive features as input, to produce a trained model; and providing the trained model to at least one other hardware processor for the purpose of generating synthetic training data.

According to a second aspect, a method for training a generative machine learning model comprises: extracting a plurality of real primitive features from a plurality of real images captured by a sensor in a physical environment; extracting a plurality of other primitive features from a plurality of other images depicting another physical environment; training a generative machine learning model to produce a refined image in response to a synthetic image, the training using the plurality of real images, the plurality of real primitive features, the plurality of other images and the plurality of other primitive features, where at least part of the generative machine learning model is adapted for receiving the plurality of real primitive features and additionally or alternatively the plurality of other primitive features as input, to produce a trained model; and providing the trained model to at least one other hardware processor for the purpose of generating synthetic training data.

According to a third aspect, a system for generating synthetic training data comprises: at least one hardware processor, configured for: accessing a trained machine learning model trained to produce a refined image in response to a synthetic image, the trained machine learning model trained by a training method comprising: extracting a plurality of real primitive features from a plurality of real images captured by a sensor in a physical environment; extracting a plurality of other primitive features from a plurality of other images depicting another physical environment; training a generative machine learning model, using the plurality of real images, the plurality of real primitive features, the plurality of other images and the plurality of other primitive features, where at least part of the generative machine learning model is adapted to receive the plurality of real primitive features and additionally or alternatively the plurality of other primitive features as input, to produce a trained model; and providing the trained model to at least one other hardware processor for the purpose of generating synthetic training data; and generating one or more refined synthetic images by providing the trained machine learning model with one or more other synthetic images produced by another simulation engine, simulating yet another plurality of images captured by yet another sensor in yet another physical environment equivalent to yet another simulated environment. Generating synthetic training data using a machine learning model trained using a plurality of primitive features provided as input to at least part of the model increases photorealism of the generated synthetic training data compared to other synthetic training data generated using a model trained without input comprising the plurality of primitive features.

According to a fourth aspect, a system for producing an autonomous driving system comprises: at least one hardware processor, configured for: accessing synthetic training data generated by a data generation method comprising: extracting a plurality of real primitive features from a plurality of real images captured by a sensor in a physical environment; extracting a plurality of other primitive features from a plurality of other images depicting another physical environment; training a generative machine learning model, using the plurality of real images, the plurality of real primitive features, the plurality of other images and the plurality of other primitive features, where at least part of the generative machine learning model is adapted to receive the plurality of real primitive features and additionally or alternatively the plurality of other primitive features as input, to produce a trained model; and providing the trained model to at least one other hardware processor for the purpose of generating synthetic training data; and providing the synthetic training data to at least one machine learning model of the autonomous driving system for the purpose of training the at least one machine learning model and additionally or alternatively verifying the at least one machine learning model and additionally or alternatively validating the at least one machine learning model and additionally or alternatively testing the at least one machine learning model. Training a model, testing the model, validating the model, verifying the model or any combination thereof, using synthetic training data generated using another machine learning model trained using a plurality of primitive features provided as input to at least part of the other model increases accuracy of an output of the trained model compared to a model trained using other synthetic training data that is less photorealistic.

With reference to the first and second aspects, in a first possible implementation of the first and second aspects the plurality of other images is a plurality of other real images captured by another sensor in another physical environment.

With reference to the first and second aspects, in a second possible implementation of the first and second aspects the plurality of other images is a plurality of synthetic images produced by a simulation engine, simulating a plurality of images captured by a sensor in another physical environment equivalent to a simulated environment simulated by the simulation engine. Optionally, the at least one hardware processor is further configured for: computing a plurality of reconstructed synthetic images using the plurality of other primitive features; and training the generative machine learning model, further using the plurality of reconstructed synthetic images, where at least yet another part of the generative machine learning model is adapted for receiving the plurality of reconstructed synthetic images as input. Adapting the generative machine learning model to receive a plurality of reconstructed synthetic images computed using the plurality of other primitive features extracted from the plurality of other images allows further emphasizing the plurality of other primitive features in training the generative machine learning model and thus reduces a likelihood of the generative machine learning model being over fitted to a training dataset used to train said generative machine learning model.

With reference to the first and second aspects, in a third possible implementation of the first and second aspects the at least one hardware processor is further configured for: computing a plurality of reconstructed real images using the plurality of real primitive features; and training the generative machine learning model, further using the plurality of reconstructed real images, where at least another part of the generative machine learning model is adapted for receiving the plurality of reconstructed real images as input. Adapting the generative machine learning model to receive a plurality of reconstructed real images computed using the plurality of real primitive features extracted from the plurality of real images allows further emphasizing the plurality of real primitive features in training the generative machine learning model and thus reduces a likelihood of the generative machine learning model being over fitted to a training dataset used to train said generative machine learning model.

With reference to the first and second aspects, in a fourth possible implementation of the first and second aspects the generative machine learning comprises a plurality of layers and the at least part of the generative machine learning model that is adapted for receiving the plurality of real primitive features and additionally or alternatively the plurality of other primitive features as input comprises at least one layer of the plurality of layers. Optionally, the at least one layer is configured for receiving as input a plurality of primitive features from at least one other layer of the plurality of layer and the at least one layer is modified to receive as input the plurality of real primitive features and additionally or alternatively the plurality of other primitive features in addition to receiving the plurality of primitive features from the at least one other layer. Adapting one or more layers of the generative machine learning model allows controlling where in the generative machine learning model's computation the primitive features are introduced, increasing their contribution to the accuracy of the output produced by the generative machine learning model and thus increasing accuracy of the output produced by the trained generative machine learning model. In addition, the adapting one or more layers of the generative machine learning model is simpler than modifying the entire generative machine learning model, reducing a risk of introducing errors into the generative machine learning model and thus increasing accuracy of its output.

With reference to the first and second aspects, in a fifth possible implementation of the first and second aspects the plurality of real primitive features comprises at least one of: a color histogram, a texture value, a depth map, an edge, a curve, a gradient, a degree of blurriness, a metallic property, and a segmentation map, and the plurality of other primitive features comprises at least one of: a color histogram, a texture value, a depth map, an edge, a curve, a gradient, a degree of blurriness, a metallic property, and a segmentation map. These primitive features can be used to identify an underlying pattern in the one or more sets of images used to train the machine learning model. Adding emphasis in training a machine learning model to any of these primitive features emphasizes the underlying pattern in the one or more sets of images used to train the machine learning model and reduces a risk of the machine learning model learning to recognize other patterns that are noise.

With reference to the first and second aspects, in a sixth possible implementation of the first and second aspects the generative machine learning model is a generative adversary network comprising a refiner and a discriminator. Optionally, the discriminator comprises a first plurality of layers and the at least part of the generative machine learning model is at least one first layer of the first plurality of layers. Optionally, the discriminator uses the plurality of real primitive features and additionally or alternatively the plurality of other primitive features as constraints when classifying an input image. Adapting the discriminator to receive a plurality of primitive features while training, and additionally or alternatively using the plurality of primitive features as constraints by the discriminator improves accuracy of one or more classifications computed by the discriminator and as a result increases accuracy of the refiner trained using the discriminator. Optionally, the refiner comprises a second plurality of layers and at least one second layer of the second plurality of layers is adapted for receiving the plurality of real primitive features and additionally or alternatively the plurality of other primitive features as input. Optionally, the refiner uses the plurality of real primitive features and additionally or alternatively the plurality of other primitive features as constraints when generating a refined image. Adapting the refiner to receive a plurality of primitive features while training, and additionally or alternatively using the plurality of primitive features as constraints by the refiner improves accuracy of output produced by the refiner. Optionally, the at least one hardware processor is further configured for providing the discriminator to at least one additional hardware processor for the purpose of classifying one or more objects in input data.

With reference to the first and second aspects, in a seventh possible implementation of the first and second aspects the generative machine learning model is a stable diffusion model.

With reference to the third aspect, in a first possible implementation of the third aspect the at least one hardware processor is further configured for providing the one or more refined synthetic images to a perception model for the purpose of training the perception model and additionally or alternatively validating the perception model and additionally or alternatively verifying the perception model and additionally or alternatively testing the perception model. Optionally, the perception model is at least part of an autonomous computerized system. Optionally, the autonomous computerized system is one of: an advanced driver-assistance system (ADAS), and an autonomous driving system (ADS). Training a perception model, testing the perception model, validating the perception model, verifying the perception model or any combination thereof, using synthetic training data generated using another machine learning model trained using a plurality of primitive features provided as input to at least part of the other model increases accuracy of an output of the trained perception model compared to a perception model trained using other synthetic training data that is less photorealistic.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments pertain. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary system for training a generative adversary network;

FIG. 2 is a schematic block diagram of an exemplary system, according to some embodiments;

FIG. 3 is a schematic block diagram of an exemplary sub-system for training a generative machine learning model, according to some embodiments;

FIG. 4 is another schematic block diagram of the exemplary sub-system for training a generative machine learning model, according to some embodiments;

FIG. 5 is a flowchart schematically representing an optional flow of operations for training a generative machine learning model, according to some embodiments;

FIG. 6 is a flowchart schematically representing an optional flow of operations for generating synthetic data, according to some embodiments;

FIG. 7 is a flowchart schematically representing an optional flow of operations for training an autonomous computerized system, according to some embodiments;

FIG. 8 is a set of exemplary images, according to some embodiments; and

FIG. 9 is another set of exemplary images, according to some embodiments.

### DETAILED DESCRIPTION

The following description focuses on generating synthetic digital images, where a digital image is a collection of captured data-points captured by a sensor in a capture interval of time. For brevity, henceforth the term “image” is used to mean “digital image” and the terms are used interchangeably. For simplicity, the following description focuses on images captured by a camera, however the described methods may be applied to other captured images captured by other sensors. Some other examples of a sensor are a radar, a LIDAR sensor, an ultrasonic sensor, a thermal sensor, and a far infra-red (FIR) sensor. A camera may capture visible light frequencies. A camera may capture invisible light frequencies such as infra-red light frequencies and ultra-violet light frequencies.

For brevity, the following description focuses on generating synthetic data for training an ADS, however some of the methods and systems described below may be applied to other computerized systems that comprise one or more perception models, for example an ADAS. In addition, the methods and systems described below may additionally or alternatively be used for testing an autonomous computerized system, additionally or alternatively validating an autonomous system, and additionally or alternatively verifying an autonomous system. In addition, some of the methods and systems described below may be applied for generating synthetic data in fields other than machine perception, for example for a video game or for a movie.

When generating synthetic data for training or testing an ADS there is a need to generate data that exhibits a realistic look (for example for visual sensors). A photo-realistic synthetic image is an image that looks as though it were photographed by a camera. A rendering engine can generate a synthetic image according to semantic descriptions of the required image. However, many images generated by a rendering engine will not appear photo-realistic. Some characteristics that cause an image to appear non-realistic are: color saturation in some areas of the image; gradients (or lack thereof) in the color of the sky, a road, or any other surface in the image; and lighting and shading.

There is a need to generate photo-realistic looking synthetic environments for a variety of applications. Video games are one example where there is a need for realistic looking synthetic environments. Another example is animation movies. When training an ADS, using realistic looking simulation data may improve the quality of the ADS.

A generative machine learning computer model is a type of computer model that is designed to generate new data samples that are similar to data it was trained on. A possible way to generate realistic looking images is to use a generative machine learning computer model to refine synthetic images generated by a simulation generation model (sometimes also called an engine). Such a generative machine learning computer model is known as a refiner. A refiner may be used to refine a synthetic image to make it look more realistic.

A Deep Neural Network (DNN) is a type of machine learning model that is a neural network that has multiple layers, allowing it to learn and represent complex patterns and features in data. One possible way to train a refiner is using a Generative Adversarial Network (GAN), having a refiner for generating images and a discriminator for classifying images, where the refiner is a DNN trained to generate a photo-realistic image in response to an input image and where the discriminator is another DNN trained to classify an input image according to how realistic the input image appears. Another type of refiner is a stable diffusion model. A stable diffusion model is a DNN trained to remove noise from an input image, where the DNN is trained using diffusion techniques.

For brevity, unless otherwise noted henceforth the term “model” is used to mean “machine learning model”, and the terms are used interchangeably.

The field of machine learning suffers from overfitting, where a model performs well on training data but poorly on previously unseen data, even when the unseen data is drawn from the same distribution of data from which the training data was curated. One possible cause of overfitting is when the model learns noise in the training data instead of the underlying patterns. This results in poor performance on unseen data. For example, an over fitted refiner might produce photo-realistic results on images from its training dataset, but when given new images that differ significantly from the training set, its performance might degrade. The refiner might not understand the broader context of images it hasn't seen before, resulting in poor handling of variations in lighting or backgrounds, poor enhancement, introduction of artifacts, and failure to preserve essential details in new images.

While it is expected that larger training sets would reduce overfitting, this is not always the case. Merely increasing a training data set does not guarantee its diversity. There exist methods for checking and enhancing diversity and coverage of a training dataset, for example in terms of object types, object sizes, distances between objects, object orientation, scene lighting etc. Practical constraints, such as limited storage capacity and training time, impose restrictions on the size of a training dataset for training a model. Consequently, the potential reduction in overfitting the model by enlarging the training dataset is constrained.

There exist various methods for reducing overfitting of a trained model. Some methods include regularization, for example introducing penalties to the model's optimization process, discouraging it from learning overly complex or noisy patterns. However, regularization can lead to a reduction in the model's capacity to learn complex relationships, which might result in important features or patterns being suppressed. Some other methods for reducing overfitting of a trained model include early stopping, which involves monitoring the performance of the model on a separate validation dataset and stopping the training process once the performance on the validation data starts to deteriorate or plateau, instead of continuing until the model fits the training data perfectly. However, early stopping might stop the training process before the model has fully converged or reached its optimal performance. If a stopping criterion is set too early, the model might not have learned all the relevant patterns in the data, leading to suboptimal performance.

Striking the right balance between reducing overfitting and obtaining a model's optimal performance can be challenging.

Specifically when training an image refiner, another method for reducing overfitting is using ground truth information describing a scene in which an image of the training data set what captured or produced.

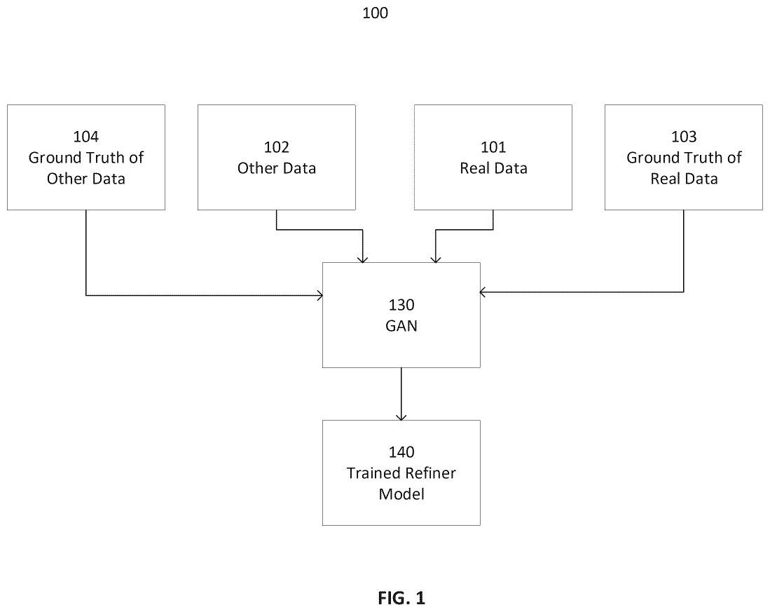

Reference is made to FIG. 1, showing a block diagram of an exemplary system 100 for training a GAN, according to some current common GAN training practices.

According to current common GAN training practices, the discriminator of GAN 130 is trained by alternately inputting to the discriminator a plurality of synthetic images 172 generated by the refiner (provided as negative examples) and a plurality of real images 101 captured by one or more sensors in a physical environment (provided as positive examples). Some examples of a sensor include, but are not limited to, a camera, a video camera, a radar, a LIDAR sensor, an ultrasonic sensor, a thermal sensor, and a far infra-red (FIR) sensor. According to such GAN training practices, the refiner of GAN 130 is trained by inputting to the discriminator a plurality of synthetic images generated by the GAN's refiner for classification, inputting to the refiner one or more outputs of the discriminator, and modifying at least some weight values of the refiner to reduce a refiner error value computed using the one or more outputs of the discriminator.

To increase photorealism of the synthetic images generated by the refiner, in some methods the GAN 130 is trained using ground truth information 174 of the synthetic images and additionally or alternatively using labels that identify objects identified in the synthetic images when classifying an image. In some methods, the GAN 130 is additionally trained using ground truth information 103 of the real images. Model 140 comprises the refiner and the discriminator trained using the above method.

Ground truth is not always available when training the generative model. In addition, when training the generative model in a GAN, using ground truth does not overcome overfitting in the discriminator sufficiently, resulting in a poor quality refiner trained using such a discriminator.

In machine learning, the term feature refers to an independent variable in a machine learning model. A feature may be a high level, derived feature. For example, in computer vision, a high level feature may be an object identified in an image, some examples including a dog, a person, and a vehicle. A feature may be a low level, or primitive, feature. Some examples of a primitive feature in computer vision include, but are not limited to, a color, a color histogram, a texture value, a depth map, an edge, a curve, a gradient, a degree of blurriness, a metallic property, and a segmentation map, assigning a label or category to one or more pixels of a plurality of pixels of the image.

Deep Learning (DL) is used to refer to methods aimed at learning feature hierarchies, with features from higher levels of a hierarchy formed by composition of lower level features. For example, a dog may be identified by a composition of one or more paws, a body, a tail and a head. In turn, a head may be identified by a composition of one or two eyes, one or two ears and a snout. An ear may be identified by a certain shape of an outlining edge. An eye may be identified by a certain shape of an outlining edge and by a shininess of an interior area. As mentioned above, a deep neural network (DNN) is a machine learning model that uses a neural network having a plurality of layers.

The present disclosure, in some embodiments described herewithin, proposes adding to training data, comprising one or more sets of images and provided to a model for training, a plurality of primitive features extracted from the one or more sets of images. Training a model by adding the plurality of primitive features to the one or more sets of images allows emphasizing features that are of importance to the underlying patterns in the one or more sets of images, and reduces the likelihood of the model learning noise in the one or more sets of images, i.e. become over fitted to the training data.

Optionally, the plurality of primitive features are a subset of a set of features of the one or more sets of images. Using only some of the set of features of the one or more sets of images allows giving more emphasis to features that are of importance to the underlying patterns in the one or more sets of images than to features that contribute to other patterns that are essentially noise, reducing overfitting of the model and increasing the accuracy of the model's output. Using as the plurality of primitive features only some of the set of features gives the plurality of primitive features more weight in the operation of the model, some examples being more weight in a classifier's discrimination, more weight in a diffusion process and more weight in an optimization process.

Optionally, the present disclosure proposes, in some embodiments described herewithin, adapting at least part of the model for receiving the plurality of primitive features. When the model comprises a plurality of layers, in some embodiments the present disclosure proposes modifying one or more layers of the model to receive the plurality of primitive features. Optionally, the one or more layers of the model receive the plurality of primitive features as input in addition to receiving other primitive features from one or more other layers of the plurality of layers of the model. Optionally, the one or more layers of the model receive the plurality of primitive features as input alternatively to receiving the other primitive features from the one or more other layers of the plurality of layers of the model. Modifying one or more layers of the model to receive the plurality of primitive features allows controlling at what stage of the model's processing the features are introduced, increasing the plurality of primitive features contribution to an output of the model and thus reducing overfitting of the model.

In addition, in some embodiments described herewithin, the present disclosure proposes further adding to the training data a plurality of reconstructed images, computed using the plurality of primitive features, and training the model further using the plurality of reconstructed images. Optionally, at least another part of the model is adapted for receiving the plurality of reconstructed images as input. Using images reconstructed from the plurality of primitive features provides the plurality of primitive features to the model in the context of an image, giving further emphasis to the plurality of primitive features in training the model, increasing the likelihood of the model learning features that are of importance to the underlying patterns and reducing the likelihood of the model learning other patterns that are noise and being over fitted to the training data.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java, Object-Oriented Fortran or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), a coarse-grained reconfigurable architecture (CGRA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

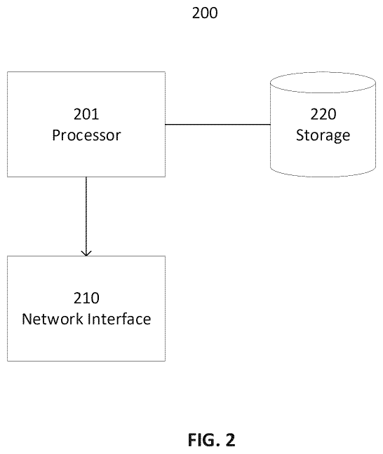

Reference is now made also to FIG. 2, showing a schematic block diagram of an exemplary system 200, according to some embodiments. In such embodiments, at least one hardware processor 201 (henceforth processing unit 201) is connected to at least one non-volatile digital storage 220 (henceforth storage 220), optionally to access one or more sets of images. Optionally, processing unit 201 retrieves from storage 220 synthetic training data. Optionally the synthetic training data comprises one or more refined synthetic images, generated by a model trained to produce a refined image in response to a synthetic image. Optionally, processing unit 201 executes the trained model and stores the one or more refined synthetic images on storage 220.

Some examples of a non-volatile digital storage include a hard disk drive, a solid state drive (SSD), a network connected storage and a storage network. Optionally storage 220 is electrically connected to processing unit 201, for example when storage 220 is a hard disk drive or a solid state drive. Optionally, storage 220 is connected to processing unit 201 via one or more digital communication network interface 210, for example when storage 220 is a storage network or a network attached storage.

For brevity, henceforth the term “network interface” is used to mean “one or more digital communication network interface” and the terms are used interchangeably. Optionally, network interface 210 is connected to a local area network (LAN), for example an Ethernet network or a Wi-Fi network. Optionally, network interface 210 is connected to a wide area network (WAN), for example a cellular network or the Internet.

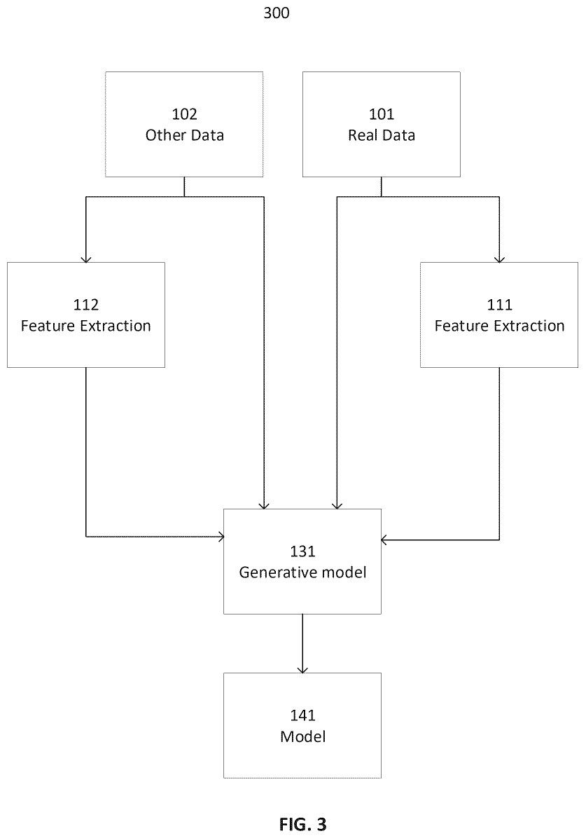

In some embodiments described herewithin, system 200 is used to train a generative machine learning model. Reference is now made also to FIG. 3, showing a schematic block diagram of an exemplary sub-system 300 of system 200 for training a generative machine learning model, according to some embodiments. In such embodiments, feature extraction 111 extracts a plurality of real primitive features from the plurality of real images 101.

Optionally, other feature extraction 112 extracts a plurality of other primitive features from a plurality of other images 102, depicting another physical environment. Optionally, the plurality of other images 102 is a plurality of other real images captured by another sensor in another physical environment. Optionally, the other physical environment is the physical environment where the plurality of real images 101 was captured. Optionally, the other sensor is the sensor that captured the plurality of real images 101. Optionally, the plurality of other images 102 is a plurality of synthetic images, produced by a simulation engine simulating a plurality of images captured by the other sensor in the other physical environment is equivalent to another simulated environment simulated by the simulation engine.

Optionally, generative model 131 is provided with the plurality of real images 101, the plurality of real data primitive features, the plurality of other images 102 and the plurality of other primitive features, for the purpose of training generative model 131.

Optionally, the generative model 131 is a deep neural network (DNN), comprising a plurality of layers. Optionally, one or more of the plurality of layers of the model 131 are modified to accept a plurality of primitive features as input. Optionally, the plurality of primitive features comprises the plurality of other primitive features, and additionally or alternatively the plurality of real primitive features. Optionally, the one or more modified layers are adapted for receiving the plurality of primitive features in addition to or alternatively to receiving another plurality of primitive features from one or more other layers in the model 131.

Optionally, generative model 131 is a stable diffusion model.

Optionally, generative model 131 is a GAN comprising a refiner and a discriminator. Optionally, the plurality of real images 101, the plurality of real data primitive features, the plurality of other images 102 and the plurality of other primitive features are provided to the GAN to train the discriminator and additionally or alternatively for the purpose of training the refiner.

Optionally, the discriminator comprises a first plurality of layers, for example the discriminator may be a DNN comprising the first plurality of layers. Optionally, the one or more of the plurality of layers of the model 131 modified to accept the plurality of primitive features as input comprise at least one first layer of the first plurality of layers of the discriminator. Optionally, the refiner comprises a second plurality of layers, for example the refiner may be another DNN comprising the second plurality of layers. Optionally, the one or more of the plurality of layers of the model 131 modified to accept the plurality of primitive features as input comprise at least one second layer of the second plurality of layers of the refiner.

A discriminator trained using the plurality of primitive features is more accurate (i.e. produces more accurate classifications of input images) than a discriminator trained using ground truth and additionally or alternatively labels that describe a plurality of input images comprising the plurality of real images and additionally or alternatively the plurality of other images. Optionally, the discriminator uses the plurality of primitive features as constraints when classifying an input image indicating one or more details that are important to recognize, further increasing accuracy of the discriminator.

A refiner trained using a discriminator trained as described above is challenged by a more accurate discriminator and as a result is more accurate (that is, produces synthetic images that are more photo realistic) than a refiner trained using a discriminator trained without using the plurality of primitive features. Optionally, the refiner uses the plurality of primitive features as constraints when generating a refined image, indicating one or more details that are important to generate such that they are recognizable by the discriminator, increasing accuracy of the refiner compared to a refiner trained using ground truth and additionally or alternatively labels that describe the plurality of input images.

Optionally, after training, the generative model 131 comprises trained model 141. Optionally, trained model 141 is a trained refiner. When generative model 131 is a GAN, trained model 141 optionally comprises a trained refiner and additionally or alternatively a trained discriminator.

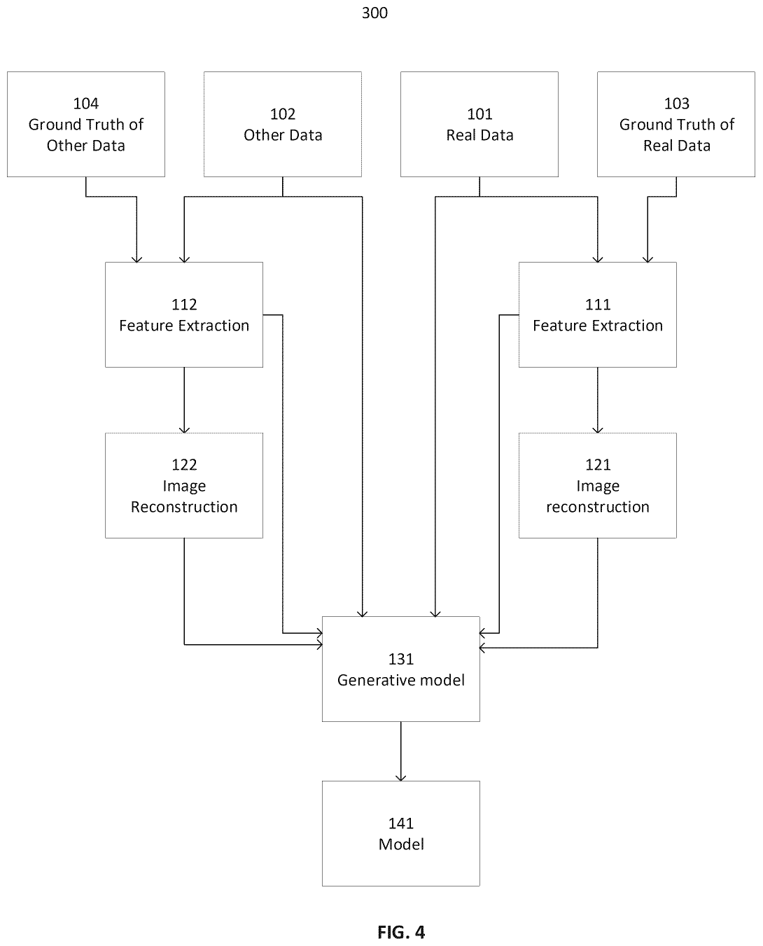

Reference is now made also to FIG. 4, showing another schematic block diagram of the exemplary sub-system 300, according to some embodiments. In such embodiments, image reconstruction 121 computes a plurality of reconstructed real images using the plurality of real primitive features. Optionally, the plurality of reconstructed real images is provided to the generative model 131 for training, alternatively or additionally to the plurality of real primitive features. Optionally, other image reconstruction 122 computes a plurality of reconstructed other images using the plurality of other primitive features. When the plurality of other images is a plurality of synthetic images, other image reconstruction 122 computes a plurality of reconstructed synthetic images. Optionally, the plurality of reconstructed other images is provided to the generative model 131 for training, alternatively or additionally to the plurality of other primitive features. Optionally, at least another part of the generative model 131 is adapted for receiving the plurality of reconstructed other images and additionally or alternatively the plurality of reconstructed real images.

Using the plurality of primitive features allows increasing photo-realism of synthetic data generated by the refiner without using ground truth, and when the model 131 is a GAN increases accuracy of the GAN's discriminator's classification without using ground truth. Optionally, in some embodiments the feature extraction 111 uses ground truth 103 of the real images when extracting the plurality of real primitive features. Optionally, the other feature extraction 112 uses ground truth 104 of the plurality of other images when extracting the plurality of other primitive features. Using ground truth when extracting a plurality of primitive features increases accuracy of the plurality of primitive features, and thus increases accuracy of the trained model 141.

To train a generative model, in some embodiments system 200, comprising sub-system 300, implements the following optional method.

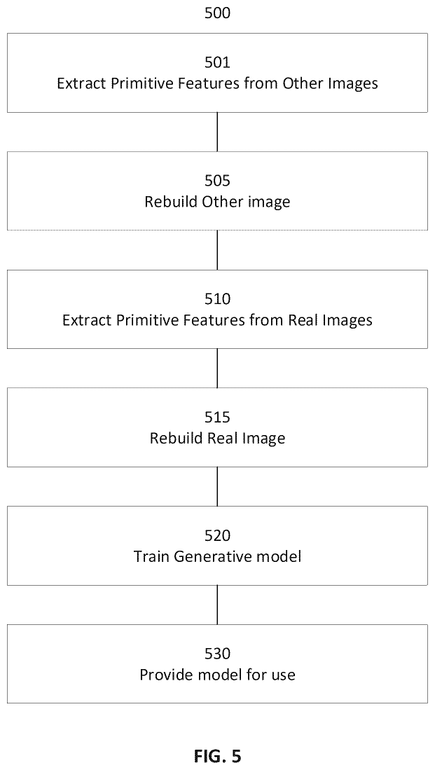

Reference is now made also to FIG. 5, showing a flowchart schematically representing an optional flow of operations 500, according to some embodiments. In such embodiments, in 501 processing unit 201 implements feature extraction 111 and extracts a plurality of real primitive features from the plurality of real images 101. In 510, processing unit 201 optionally implements other feature extraction 112 and extracts a plurality of other primitive features from the plurality of other images 102. In 520, processing unit 201 optionally trains generative model 131 to produce a refined image in response to a synthetic image. Optionally, processing unit 201 trains generative model 131 using the plurality of real image 101, the plurality of real primitive features, the plurality of other images 102 and the plurality of other primitive features. Optionally, training generative model 131 produces trained model 141. Optionally, in 530, processing unit 201 provides the trained model 141 or part of the trained model 141 to one or more other hardware processors for the purpose of generating synthetic training data. For example, the trained refiner may be used to generate training data for training a perception model that receives input from a specific real camera sensor. In this example, initial training data may be generated by an external simulation system and the trained refiner may be used to increase photo-realism of the training data according to a plurality of properties of the specific real camera sensor. In another example the trained refiner is used to increase photo-realism of synthetic data that is then provided to train, test, validate and/or verify an autonomous system.

Additionally or alternatively, processing unit 201 provides the model 141 or part of the model 141 to the one or more other hardware processors for other purposes. For example, the trained discriminator may be used to classify other data produced by another generation system, for example for the purpose of assessment and ranking, for example in a web-based system for uploading data.

Optionally, the one or more other hardware processors are processor 201. Optionally the one or more other hardware processors are connected to processor 201 via network interface 210. Optionally the one or more other hardware processors are connected to storage 220, optionally via network interface 210.

When using reconstructed images to train the generative model 131, in 505 processing unit 201 optionally implements other image reconstruction 122 and computes a plurality of other reconstructed images using the plurality of other primitive features. When the plurality of other images is a plurality of synthetic images, the plurality of other reconstructed images is a plurality of reconstructed synthetic images. Optionally, in 530 the processing unit 201 trains the generative model 131 further using the plurality of other reconstructed images. In 515, the processing unit 201 optionally implements image reconstruction 121 and computes a plurality of reconstructed real images using the plurality of real primitive features. Optionally, in 530 the processing unit 201 trains the generative model 131 further using the plurality of real reconstructed images.

In some embodiments, system 200 is used to generate synthetic training data. In such embodiments system 200 implements the following optional method.

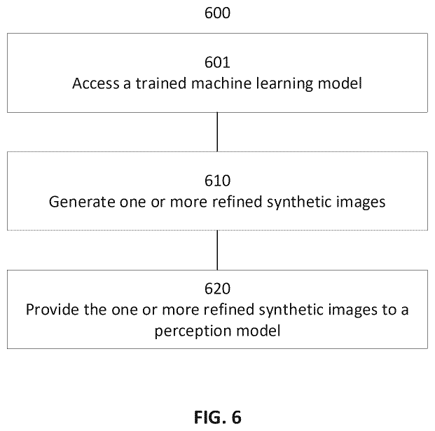

Reference is now made also to FIG. 6, showing a flowchart schematically representing an optional flow of operations 600 for generating synthetic data, according to some embodiments. In such embodiments, in 601 the processing unit 201 accesses trained model 141. Optionally, trained model 141 is produced by training generative model 131 using method 500. In 610, the processing unit 201 optionally generates one or more refined synthetic images by providing trained model 141 one or more other synthetic images produced by another simulation engine. Optionally, the other simulation engine simulates yet another plurality of images captured by yet another sensor in yet another physical environment that is equivalent to yet another simulated environment.

In 620, processing unit 201 optionally provides the one or more refined synthetic images to a perception model, optionally to train the perception model. Optionally, processing unit 201 provides the one or more refined synthetic images to the perception model to validate the perception model. Optionally, processing unit 201 provides the one or more refined synthetic images to the perception model to verify the perception model. Optionally, processing unit 201 provides the one or more refined synthetic images to the perception model to test the perception model.

Optionally, processing unit 201 provides the one or more refined synthetic images by storing the one or more refined synthetic images on storage 220. Optionally, processing unit 201 provides the one or more refined synthetic images by sending the one or more refined synthetic images via network interface 210.

Optionally, the perception model is at least part of an autonomous computerized system, for example an ADS or an ADAS.

In some embodiments, system 200 is used to produce an autonomous computerized system. In such embodiments system 200 implements the following optional method.

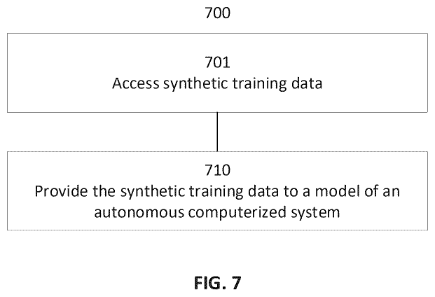

Reference is now made also to FIG. 7, showing an optional flow of operations 700 for training an autonomous computerized system, according to some embodiments. In such embodiments, in 701 the processing unit 201 accesses synthetic training data. Optionally, the synthetic training data is generated using method 600. Optionally, the processing unit 201 retrieves the synthetic training data from storage 220. Optionally, the processing unit 201 receives the synthetic training data via network interface 210, optionally from yet another hardware processor.

In 710, the processing unit 201 optionally provides the synthetic training data to one or more machine learning models of an autonomous computerized system for training the one or more machine learning models. Optionally, the one or more machine learning models comprise at least one perception model. Optionally, the autonomous computerized system is an ADS. Optionally, the autonomous computerized system is an ADAS. Optionally, the processing unit 201 provides the synthetic training data to the one or more machine learning models for testing the one or more machine learning models. Optionally, the processing unit 201 provides the synthetic training data to the one or more machine learning models for verifying the one or more machine learning models. Optionally, the processing unit 201 provides the synthetic training data to the one or more machine learning models for validating the one or more machine learning models.

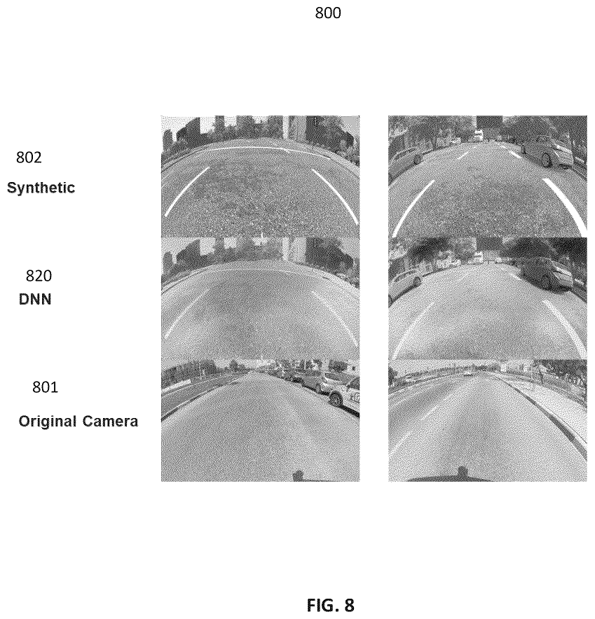

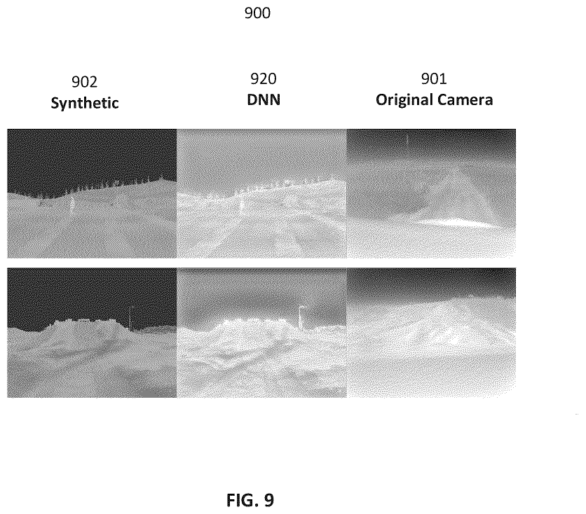

Reference is now made also to FIGS. 8 and 9, showing exemplary images according to some embodiments described herewithin. Referring to FIG. 8, set of images 800 shows images pertaining to a sensor that captures visible light. Images 801 are images captured by a real camera, and images 802 are synthetic images created by a simulation engine. Images 820 are refined synthetic images created by a refiner trained using a system and a method as described herewithin.

Similarly, referring to FIG. 9, set of images 900 shows images pertaining to a sensor that captures infrared light. Images 901 are images captured by a real infrared camera, and images 902 are synthetic images created by a simulation engine. Images 920 are other refined synthetic images created by the refiner trained using a system and a method as described herewithin.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant generative machine learning models and primitive features will be developed and the scope of the terms “generative machine learning model” and “primitive feature” are intended to include all such new technologies a priori.

As used herein the term “about”refers to ±10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-21. (canceled)

22. A system for generating synthetic data, comprising:
at least one hardware processor, configured for:
adapting at least part of a generative machine learning model for receiving a plurality of primitive features as input, where the plurality of primitive features are a subset of a set of features of one or more digital images, and where a primitive feature is an independent variable in a machine learning model and is derived from one or more digital images; and
generating one or more refined synthetic images by providing the generative machine learning model with one or more input images, where the generative machine learning model uses the plurality of primitive features as constraints when generating a refined image.

23. The system of claim 22, wherein the plurality of primitive features comprises at least one of: a color histogram, a texture value, and a metallic property.

24. The system of claim 22, wherein the plurality of primitive features comprises at least one of: a depth map, an edge, a curve, a gradient, a degree of blurriness, and a segmentation map.

25. The system of claim 22, wherein the generative machine learning model comprises a plurality of layers;
wherein the at least part of the generative machine learning model that is adapted for receiving the plurality of primitive features as input comprises at least one layer of the plurality of layers; and
wherein the at least one layer is modified to receive the plurality of primitive features as input in addition to receiving another plurality of primitive features from at least one other layer of the plurality of layers.

26. The system of claim 22, wherein the plurality of primitive features is extracted from a plurality of digital images.

27. The system of claim 22, wherein the at least one hardware processor is further configured for providing the one or more refined synthetic images to a perception model for the purpose of training the perception model and additionally or alternatively validating the perception model and additionally or alternatively verifying the perception model and additionally or alternatively testing the perception model.

28. The system of claim 27, wherein the perception model is at least part of an autonomous computerized system.

29. The system of claim 28, wherein the autonomous computerized system is one of: an advanced driver-assistance system (ADAS), and an autonomous driving system (ADS).

30. The system of claim 22, wherein the at least one hardware processor is further configured for providing the one or more refined synthetic images for at least one of: a video game and a movie.

31. The system of claim 22, wherein the generative machine learning model is trained by:
extracting a plurality of real primitive features from a plurality of real images captured by a sensor in a first physical environment, wherein a real primitive feature of the plurality of real primitive features is derived from the plurality of real images;
extracting a plurality of other primitive features from a plurality of other images depicting a second physical environment, wherein an other primitive feature of the plurality of other primitive features is derived from the plurality of other images; and
training the generative machine learning model using the plurality of real images, the plurality of real primitive features, the plurality of other images and the plurality of other primitive features as independent variables for training, where the at least part of the generative machine learning model that is adapted for receiving the plurality of primitive features as input is adapted to receive the plurality of real primitive features and additionally or alternatively the plurality of other primitive features as input.

32. The system of claim 31, wherein the plurality of other images is a plurality of other real images captured by another sensor in the second physical environment.

33. The system of claim 31, wherein the plurality of other images is a plurality of synthetic images produced by a simulation engine, simulating a plurality of images captured by a sensor in the second physical environment that is equivalent to a simulated environment simulated by the simulation engine.

34. The system of claim 33, wherein the at least one hardware processor is further configured for:
computing a plurality of reconstructed synthetic images using the plurality of other primitive features; and
training the generative machine learning model, further using the plurality of reconstructed synthetic images, where at least a second part of the generative machine learning model is adapted for receiving the plurality of reconstructed synthetic images as input.

35. The system of claim 31, wherein the at least one hardware processor is further configured for:
computing a plurality of reconstructed real images using the plurality of real primitive features; and
training the generative machine learning model, further using the plurality of reconstructed real images, where at least a third part of the generative machine learning model is adapted for receiving the plurality of reconstructed real images as input.

36. The system of claim 31, wherein the plurality of real primitive features comprises at least one of: a color histogram, a texture value, a depth map, an edge, a curve, a gradient, a degree of blurriness, a metallic property, and a segmentation map; and
wherein the plurality of other primitive features comprises at least one of: a color histogram, a texture value, a depth map, an edge, a curve, a gradient, a degree of blurriness, a metallic property, and a segmentation map.

37. The system of claim 31, wherein the generative machine learning model is a generative adversary network comprising a refiner and a discriminator;
wherein the discriminator comprises a first plurality of layers;
wherein the at least part of the generative machine learning model is at least one first layer of the first plurality of layers; and
wherein the discriminator uses the plurality of real primitive features and additionally or alternatively the plurality of other primitive features as constraints when classifying an input image.

38. The system of claim 37, wherein the at least one hardware processor is further configured for providing the discriminator to at least one additional hardware processor for the purpose of classifying one or more objects in input data.

39. The system of claim 31, wherein the generative machine learning model is a generative adversary network comprising a refiner and a discriminator;
wherein the refiner comprises a second plurality of layers;
wherein at least one second layer of the second plurality of layers is adapted for receiving the plurality of real primitive features and additionally or alternatively the plurality of other primitive features as input; and
wherein the refiner uses the plurality of real primitive features and additionally or alternatively the plurality of other primitive features as constraints when generating a refined image.

40. The system of claim 22, wherein the generative machine learning model is a stable diffusion model.

41. A method for generating synthetic data, comprising:
adapting at least part of a generative machine learning model for receiving a plurality of primitive features as input, where the plurality of primitive features are a subset of a set of features of one or more digital images, and where a primitive feature is an independent variable in a machine learning model and is derived from one or more digital images; and
generating one or more refined synthetic images by providing the generative machine learning model with one or more input images, where the generative machine learning model uses the plurality of primitive features as constraints when generating a refined image.
